(19) United States
(12) Patent Application Publication
(10) Pub. No.: US 2017/0371086 A1
(43) Pub. Date: Dec. 28, 2017

(54) Display Backlights with Reduced Mixing Distances

(71) Applicant: Apple Inc., Cupertino, CA (US)

(72) Inventors: Jun Qi, Cupertino, CA (US); Rong Liu, Sunnyvale, CA (US); Victor H. Yin, Cupertino, CA (US); Shenglin Ye, San Jose, CA (US); Sudirukkuge Tharanga Jinasundera, San Jose, CA (US); Nathan K. Gupta, San Francisco, CA (US)

(21) Appl. No.: 15/260,993

(22) Filed: Sep. 9, 2016

Related U.S. Application Data
(60) Provisional application No. 62/353,965, filed on Jun. 23, 2016.

(51) Int. Cl. F21V 8/00

(52) U.S. Cl. CPC G02B 6/0016; G02B 6/0065

(57) ABSTRACT

A display may have a backlight with a row of light-emitting diodes that emit light into an edge surface of a light guide layer. The light guide layer may have opposing planar surfaces. Light-scattering structures such as light-scattering holes that extend between the planar surfaces may be used to scatter rays of light by refraction and/or diffraction and can thereby homogenize light from the light-emitting diodes. The homogenized light may then be extracted from the light guide layer and may serve as backlight illumination for an array of pixels such as an array of liquid crystal display pixels. Light-scattering structures such as grooves, pits, bumps, and other structures for scattering light from the light-emitting diodes may be formed on the edge surface of the light guide layer to enhance light mixing.

This application claims the benefit of provisional patent application No. 62/353,965, filed Jun. 23, 2016, which is hereby incorporated by reference herein in its entirety.

### BACKGROUND

This relates generally to electronic devices with displays, and, more particularly, to displays with backlights.

Electronic devices such as computers and cellular telephones have displays. Some displays such as organic light-emitting diode displays have arrays of pixels that generate light. In displays of this type, backlighting is not necessary because the pixels themselves produce light. Other displays contain passive pixels that can alter the amount of light that is transmitted through the display to display images for a user. Passive pixels do not produce light themselves, so it is often desirable to provide backlight for a display with passive pixels.

In a typical backlight assembly for a display, a light guide plate is used to distribute backlight generated by a light source such as a light-emitting diode light source. Optical films such as a diffuser layer and prism films may be placed on top of the light guide plate. A reflector may be formed under the light guide plate to improve backlight efficiency.

A strip of light-emitting diodes may provide light to an edge of a light guide plate. Light scattering features on the upper and/or lower surfaces of the light guide plate may scatter light out of the light guide plate so that the scattered light may serve as backlight illumination for the display.

Light from the strip of light-emitting diodes is initially concentrated in the vicinity of the outputs of the light-emitting diodes. The light must travel a sufficient mixing distance into the light guide plate to become homogenized enough to be used as backlight illumination. Backlight units with large mixing distances may consume more volume within a display than desired and may give rise to unsightly display borders. On the other hand, reducing the mixing distance in a backlight too much may lead to undesired hotspots.

### SUMMARY

A display may have a backlight that provides backlight illumination for an array of pixels. The array of pixels may be an array of liquid crystal display pixels or other pixels for displaying images for a user.

The backlight may have a light guide layer that distributes backlight across the display. The light guide layer may have edge surfaces. A light source such as a row of light-emitting diodes that extends along an edge surface of the light guide layer may emit light into the edge surface of the light guide layer.

The light guide layer may have opposing planar surfaces. Light-scattering structures such as cylindrical laser-drilled light-scattering holes (through holes) that extend between the planar surfaces may be used to redirect rays of light from the light source by refraction and/or diffraction. In this way, the light-scattering holes can homogenize light from the light-emitting diodes within a reduced mixing distance. The homogenized light may be extracted from the light guide layer using light extraction features on one or both of the planar surfaces. The extracted light may serve as the backlight illumination for the array of pixels.

To enhance homogenization of the light from the light-emitting diodes, the edge surface(s) of the light guide layer may be provided with light-scattering structures such as grooves, pits, bumps, and other structures.

### BRIEF DESCRIPTION OF THE DRAWINGS

FIG. 1 is a schematic diagram of an illustrative electronic device having a display with a backlight in accordance with an embodiment.

FIG. 2 is a cross-sectional side view of an illustrative display in an electronic device in accordance with an embodiment.

FIG. 3 is a perspective view of laser processing equipment of the type that may be used for forming light scattering structures on an edge surface of a light guide layer in accordance with an embodiment.

FIG. 4 is a side view of additional laser processing equipment that may be used for forming light scattering structures for a light guide layer in accordance with an embodiment.

FIG. 5 is a diagram of illustrative operations and equipment for forming an electronic device having a display with a backlight in accordance with an embodiment.

FIG. 6 is a top view of an illustrative light guide layer with light-scattering holes such as cylindrical laser-drilled light-scattering holes in accordance with an embodiment.

FIG. 7 is a top view of a portion of an illustrative light guide layer with light-scattering structures that include multiple rows of light-scattering holes in accordance with an embodiment.

FIG. 8 is a perspective view of an edge surface of a light guide layer with illustrative light-scattering structures in accordance with an embodiment.

FIG. 9 is a cross-sectional view of an illustrative light scattering pit of the type that may serve as a light-scattering structure on the edge surface of a light guide layer in accordance with an embodiment.

FIG. 10 is a cross-sectional side view of an illustrative light scattering bump of the type that may serve as a light-scattering structure on the edge surface of a light guide layer in accordance with an embodiment.

FIG. 11 is a perspective view of an edge surface of a light guide layer with illustrative light scattering grooves in accordance with an embodiment.

FIGS. 12, 13, and 14 are top views of the edges of illustrative light guide layers with vertically extending light-scattering structures such serrated grooves in accordance with embodiments.

### DETAILED DESCRIPTION

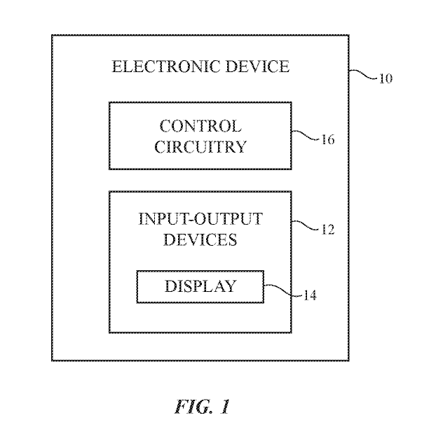

An illustrative electronic device of the type that may be provided with a display is shown in FIG. 1. As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

Input-output circuitry in device 10 such as input-output devices 12 may be used to allow data to be received by device 10 from external equipment or a user and to allow data to be provided from device 10 to external equipment or a user. Input-output devices 12 may include buttons, joysticks, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements.

Control circuitry 16 may be used to run software on device 10 such as operating system code and applications. During operation of device 10, the software running on control circuitry 16 may display images on display 14.

Device 10 may be a tablet computer, laptop computer, a desktop computer, a cellular telephone, a media player, a wristwatch device or other wearable electronic equipment, or other suitable electronic device.

Display 14 for device 10 includes an array of pixels. The array of pixels may be formed from liquid crystal display (LCD) components, electrophoretic display components, or other suitable display structures. Configurations based on liquid crystal display pixels are sometimes described herein as an example.

A display cover layer may cover the surface of display 14 or a display layer such as a color filter layer, thin-film transistor layer, or other portion of a display may be used as the outermost (or nearly outermost) layer in display 14. The outermost display layer may be formed from a transparent glass sheet, a clear plastic layer, or other transparent member.

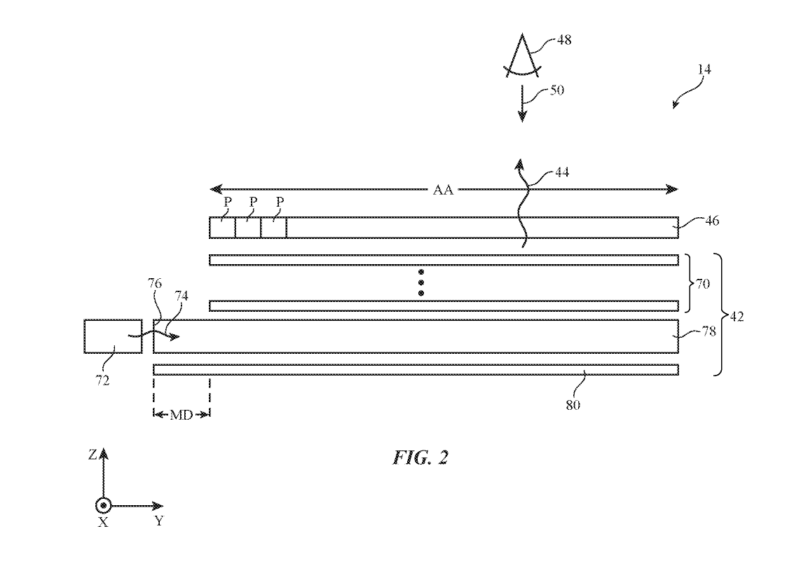

A cross-sectional side view of an illustrative configuration for display 14 of device 10 is shown in FIG. 2. As shown in FIG. 2, display 14 may include a backlight such as backlight 42 (sometimes referred to as a backlight unit, backlight system, or backlight structures) for producing backlight illumination (backlight) 44. During operation, backlight illumination 44 travels outwards (vertically upwards in dimension Z in the orientation of FIG. 2) and passes through an array of pixels P in one or more display layers 46. The array of pixels P forms an active area AA for display 14. Backlight illumination 44 illuminates any images that are being produced by pixels P for viewing by a user in active area AA. For example, backlight illumination 44 may illuminate images on display layers 46 that are being viewed by viewer 48 in direction 50.

Display layers 46 may be mounted in chassis structures such as a plastic chassis structure and/or a metal chassis structure to form a display module for mounting in a housing in device 10 or display layers 46 may be mounted directly in an electronic device housing for device 10 (e.g., by stacking display layers 46 into a recessed portion in a metal or plastic housing). Display layers 46 may form a liquid crystal display or may be used in forming displays of other types.

In a configuration in which display layers 46 are used in forming a liquid crystal display, display layers 46 may include a liquid crystal layer. The liquid crystal layer may be sandwiched between a thin-film transistor layer and a color filter layer or other substrates. These layers may, in turn, be sandwiched between an upper polarizer and a lower polarizer. Touch sensor electrodes may be formed from a layer that overlaps layer(s) 46 or may be incorporated into layer(s) 46.

Backlight 42 may include a light guide layer such as light guide layer 78. Light guide layer 78 may be formed from a transparent material such as clear glass or plastic. Layer 78 may be a molded plastic plate or may be a flexible light guide film. Light guide layer 78 may, as an example, have a thickness of 0.25-0.4 mm, more than 0.2 mm, less than 0.4 mm, or other suitable thickness. During operation of backlight 42, a light source such as light source 72 may generate light 74. Light source 72 may be, for example, an array of light-emitting diodes (e.g., a series of light-emitting diodes that are arranged in a row that extends into the page in the orientation of FIG. 2).

Light 74 from light source 72 may be coupled into edge surface 76 of light guide layer 78 and may be distributed in dimensions X and Y throughout light guide layer 78 due to the principal of total internal reflection. The upper and/or lower planar surfaces of light guide layer 78 in active area AA may include light-scattering features such as pits, bumps, grooves, or ridges that help light exit light guide layer 78 for use as backlight illumination 44. Layer 78 may be otherwise solid and free of holes (through holes) in area AA. Light source 72 may be located at the left of light guide layer 78 as shown in FIG. 2 or may be located along the right edge of layer 78 and/or other edges of layer 78.

Light 74 that scatters upwards in direction Z from light guide layer 78 may serve as backlight illumination 44 for display 14. Light 74 that scatters downwards may be reflected back in the upward direction by reflector 80. Reflector 80 may be formed from a reflective structure such as a substrate layer of plastic coated with a dielectric mirror formed from alternating high-index-of-refraction and low-index-of-refraction inorganic or organic layers.

To enhance backlight performance for backlight 42, backlight 42 may include optical films 70. Optical films 70 may include diffuser layers for helping to homogenize backlight illumination 44 and thereby reduce hotspots. Optical films 70 may also include prism films (sometimes referred to as turning films) for collimating backlight illumination 44. Optical films 70 may include compensation films for enhancing off-axis viewing or compensation films may be formed within the polarizer layers of display 14 or elsewhere in display 14.

Optical films 70 may overlap the other structures in display 14. For example, if the array of pixels P in layer(s) 46 forms an active area AA for display 14 with a rectangular footprint in the X-Y plane of FIG. 2, optical films 70 may have a matching rectangular footprint. Light guide layer 78 and reflector 80 may also have rectangular footprints.

Light 74 that exits light source 72 is initially concentrated next to the outputs of the light-emitting diodes in light source 72. Light 74 traverses a non-zero mixing distance MD through a light mixing region running along the edge of layer 78 before light 74 has spread out sufficiently in the X and Y dimensions to be homogenized enough to serve as backlight 44 for active area AA of display 14. Pixels P of active area AA overlap a corresponding portion of layer 78. Display 14 is free of pixels P over the mixing region of layer 78.

Mixing distance MD (i.e., the distance between edge surface 76 and the adjacent edge of active area AA) may, in general, have any suitable value. With one illustrative configuration, light guide holes and other light-scattering structures are formed along the edge of light guide layer 78 (e.g., on edge surface 76 and/or within the border portion of light guide layer 78 associated with mixing distance MD). The presence of these light-scattering structures may help reduce mixing distance MD to about 2.5-3 mm, less than 3 mm, less than 2.5 mm, less than 2.0 mm, less than 1.5 mm, 1-2 mm, 1-2.5 mm, or other suitable distance. Displays with minimized mixing distances MD may fit within relatively compact housing structures and allow the borders of display 14 to be minimized to enhance the appearance of device 10.

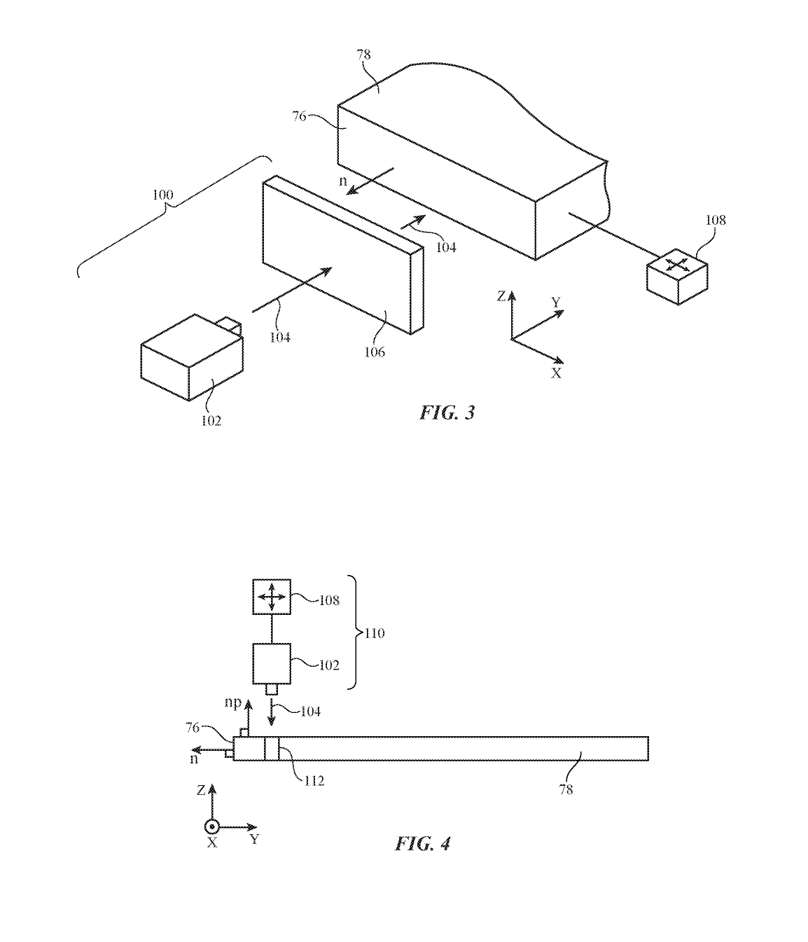

Light-scattering structures that help reduce mixing distance MD in light guide layer 78 may be formed using any suitable technique (e.g., laser processing, mechanical drilling, water jet cutting, knife cutting, die cutting, punching, molding, etc.). With one illustrative configuration, laser processing techniques are used to pattern light-scattering structure into light guide layer 78. Consider, as an example, the laser processing arrangement of FIG. 3 in which laser processing equipment 100 is being used to process edge surface 76 of light guide layer 78. In the example of FIG. 3, edge surface 76 of light guide layer 78 is being exposed to laser light 104 from laser 102. Laser 102 may be an excimer laser that produces pulses of ultraviolet light that ablate material from edge surface 76 or may be any other suitable laser that can remove material from edge surface 76 (e.g., a visible light laser, an infrared laser, etc.). Light 104 may be patterned using mask 106 (e.g., a transparent substrate formed from a material such as fused silica with an opaque pattern formed from chromium or other metal). The pattern of light 104 after light 104 passes through mask 106 may form an array of light dots surrounded by dark regions (e.g., when equipment 100 is forming an array of pits in surface 76) or may form an array of dark dots surrounded by light regions (e.g., when equipment 100 is forming an array of bumps on edge surface 76). Other patterns of light 104 may be created by mask 106, if desired (e.g., patterns for forming grooves or other recesses, ridges or other protrusions, etc.). An electrically controlled positioner such as positioner 108 that is coupled to layer 78 and/or to equipment 100 may be used to move layer 78 and equipment 100 relative to each other during processing (e.g., to smoothly scan patterned laser light 104 along the edge of layer 78, to repeatedly step equipment 100 to different locations along the edge of layer 78, etc.).

In the example of FIG. 3, laser light 104 is applied to edge surface 76 in a direction that is parallel to surface normal n of edge surface 76. If desired, laser processing equipment such as equipment 110 of FIG. 4 may be used to apply layer light 104 in a direction that is perpendicular to surface normal n of edge surface 76 and that is parallel to surface normal np of the planar upper surface of layer 78. Equipment 110 may have a laser such as laser 102 for generating laser light 104. An electrically controlled positioner such as positioner 108 may be used to control the position of laser 102 and therefore laser light 104 and/or may be used to position light guide layer 78 relative to laser 102. During operation, laser light 104 may be applied to portions of layer 78 near to edge surface 76 to form through-holes such as holes 112 that pass through layer 78 and/or to cut or otherwise pattern a desired shape into edge surface 76 (e.g., to create a serrated or grooved edge surface 76, etc.). Laser 102 may remove portions of layer 78 while laser 102 is stationary or laser 102 may be scanned along the edge of layer 78 using positioning equipment such as equipment 108. If, as an example, it is desired to form holes such as holes 112, laser 102 may be stepped between each of a number of different hole locations. At each hole location, laser 102 may produce light 104 to drill a corresponding hole 112. If desired, holes 112 may be drilled by moving laser 102 and applying a series of pulses of light 104 to layer 78 while laser 102 is moving. Cutting operations and other operations that involve application of light 104 from laser 102 to layer 78 may be performed by repeatedly stepping laser 102 along the edge of layer 78 (e.g., to each of a number of different laser processing positions) and/or may be performed by supplying constant or pulsed laser light 102 while laser 102 is being moved relative to layer 78 by positioning equipment 108.

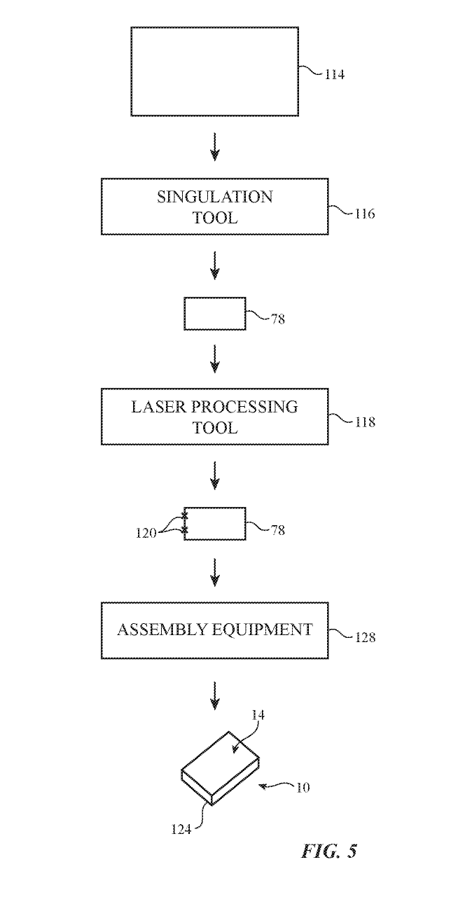

Illustrative operations and equipment of the type that may be used in forming light-scattering structures for light guide layer 78 are shown in FIG. 5.

As shown in FIG. 5, a singulation tool such as singulation tool 116 may be used to divide a large sheet of light guide material such as sheet 114 into multiple individual light guide layers such as light guide layer 78. Tool 116 may include die cutting equipment (e.g., stamping equipment), knife cutting equipment, laser cutting equipment, and/or other tools for cutting light guide layers such as layer 78 from sheet 114. After forming light guide layer 78, a laser processing tool such as laser processing tool 118 may be used to apply laser light to layer 76 to form light-scattering structures, as described in connection with laser processing tools 100 and 110 of FIGS. 3 and 4.

Laser light may, for example, be applied to edge surface 76 of layer 78 or other portions of layer 78 (e.g., the upper and/or lower planar surfaces of layer 78 along the edge of layer 78 on which edge surface 76 is formed and/or other portions of the upper and/or lower surface of layer 78). Applied laser light may selectively remove portions of layer 78 (e.g., by ablation, thermal decomposition, etc.). The light scattering features that are formed in light guide layer 78 (see, e.g., light-scattering features 120 of FIG. 5) may help scatter and thereby homogenize light 74 that is propagating in layer 78 within a relatively short mixing distance MD. The homogenization of light 74 within a short mixing distance MD in layer 78 helps avoid undesired visible hotspots along the edge of display 14 and allows the inactive border area of display 14 to be minimized. If desired, laser processing equipment and/or other equipment may be used in creating protrusions and/or recesses in the upper and/or lower surfaces of layer 78 in the portion of layer 78 that lies under active area AA of display 14 (e.g., to create an array of pits or other recesses and/or bumps or other protrusions). These structures may also be formed using mechanical embossing techniques or other light guide patterning techniques.

Following formation of light guide layer 78 with light-scattering structures 120 on edge surface 76 and/or adjacent to edge surface 76 (e.g., within the border of light guide layer 78 that is less than mixing distance MD from edge surface 76), assembly equipment 128 may be used to assemble display 14 from light guide layer 78 and other components and may be used to mount display 14 within housing 124 of electronic device 10. Assembly equipment 128 may include electrically controlled positioners, machine vision equipment, and/or other equipment for placing the layers of display 14 into housing 124 of device 10, for mounting light source 72 along edge surface 76 of light guide layer 78, and for performing other device assembly operations.

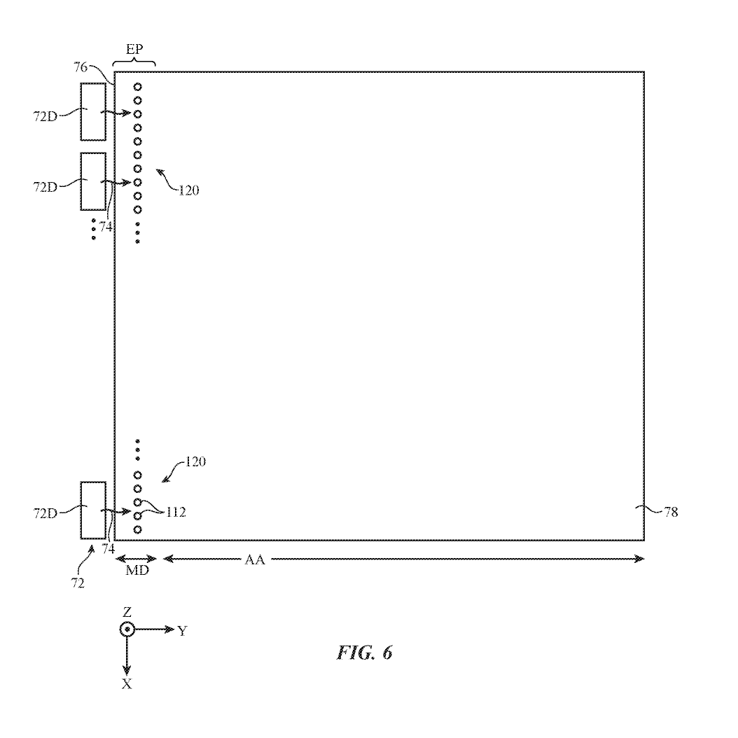

To reduce mixing distance MD, light guide layer 78 may be provided with light-scattering features 120 that are formed from one or more holes through light guide layer 78 such as holes 112 of FIG. 6. As shown in the example of FIG. 6, light source 74 may include an array of light-emitting diodes 72D extending along the edge of light guide layer 78 parallel to edge surface 76. Each light-emitting diode 72D may emit a corresponding beam of light 74 into an adjacent portion of edge surface 76.

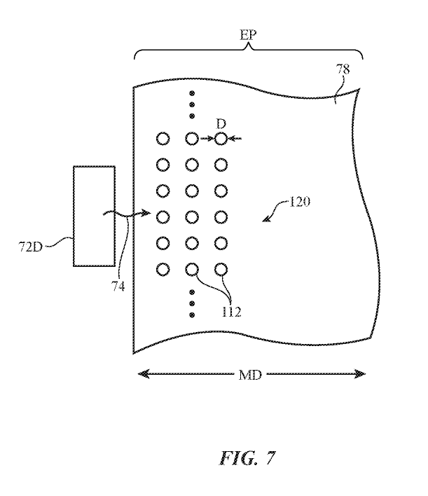

There may be one or more rows of light-scattering holes 112 in border mixing region (border portion) EP of layer 78 (i.e., in the strip of layer 78 that runs along the left edge of layer 78 and that is associated with mixing distance MD in the example of FIG. 6). In the illustrative configuration of FIG. 6, a single row of holes 112 has been formed in layer 78 to serve as light-scattering features 120 in border region EP (sometimes referred to as a light mixing region or border light mixing region). The array of pixels P of display 14 overlaps only the portion of layer 78 in active area AA that is free of holes 112. No pixels P in active area AA of display 14 overlap light mixing region EP and holes 112 along the edge of light guide layer 78. Holes 112 may extend in an uninterrupted line across layer 78 (as shown in the example of FIG. 6) or may be arranged in clusters (e.g., sets of one or more rows) that are positioned at the exits of respective light-emitting diodes 74D. The example of FIG. 6 is merely illustrative. FIG. 7 shows how layer 78 may be provided with light-scattering features 120 formed from multiple rows of holes 112 in region EP. In the example of FIG. 7, there are three row of light-scattering holes 112. There may, in general, be one or more row of holes 112.

Holes 112 may serve as lens elements that refract light 72. If desired, holes 112 may have sizes and shape that diffract light 72 in addition to or instead of refracting light 72. In general, holes 112 and/or other light-scattering structures formed in border portion EP of light-guide layer 78 may homogenize light (i.e., distribute light 72 evenly within the X-Y plane of FIG. 6) using any suitable technique.

Holes 112 may have circular outlines (i.e., holes 112 may form cylindrical openings through layer 78) or may have outlines of other suitable shapes (e.g., rectangular, triangular, hexagonal, other shapes with of cured and/or straight edges, etc.). Holes 112 may have diameters D of 25-50 microns, 10-80 microns, more than 15 microns, more than 20 microns, less than 100 microns, less than 75 microns, or other suitable sizes. The hole-to-hole spacing (pitch) of holes 112 in light-scattering features 120 may be 30-11 microns, more than 10 microns, more than 20 microns, more than 50 microns, less than 75 microns, less than 80 microns, less than 120 microns, or other suitable pitch. Holes 112 may be organized in an array having one or more rows and/or columns, may be formed in a pseudorandom pattern, or may have other suitable configurations. In configurations of the type shown in FIG. 7 there are three rows of holes 112. If desired, there may be a single row of holes 112 in light guide layer 78, two or more rows of holes 112, three or more rows of holes 112, 1-4 rows of holes 112, fewer than five rows of holes 112, or other suitable number of rows of holes.

As shown in FIG. 8, light-scattering structures 120 in border region EP may be formed from light-scattering structures 122 on edge surface 76. Structures 122 may be formed in an array with rows and columns, may be arranged in a pseudorandom pattern, or may be provided on edge surface 76 in other suitable patterns. Structures 122 may help distribute light 74 evenly within light guide plate 78 (e.g., structures 122 may help ensure that light 74 has been homogenized after traveling mixing distance MD from edge surface 76). Structures 122 may be used in combination with other light-scattering structures such as the light-scattering holes 112 of FIGS. 6 and 7 (as an example).

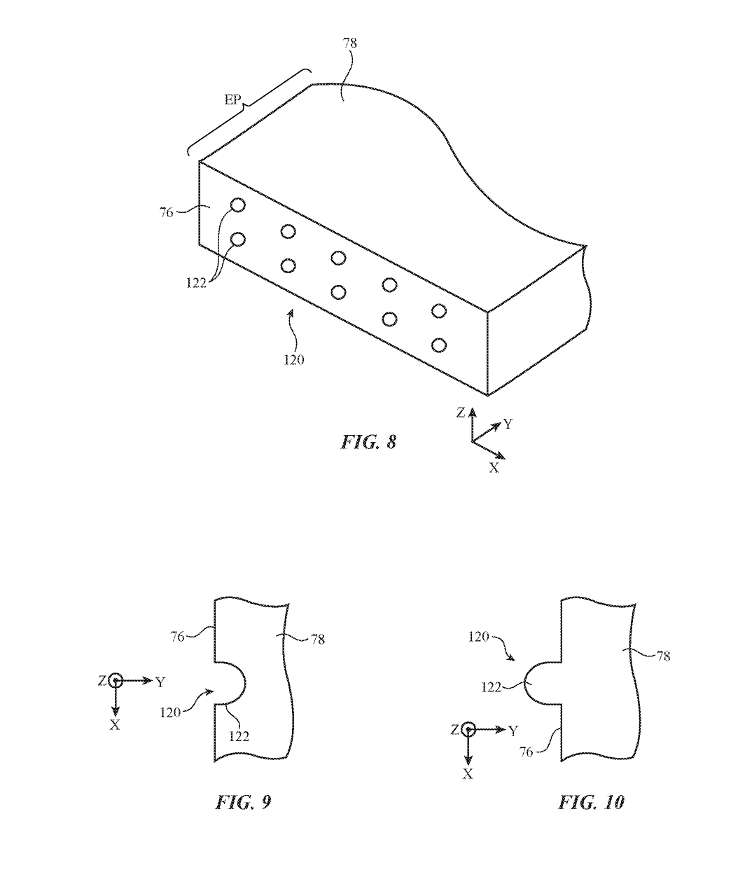

Structures 122 on edge surface 76 may have any suitable shapes that distribute light 74 by diffraction and/or refraction. As an example, structures 122 may be recesses such as semispherical pits or other pits in surface 76, as shown by the cross-sectional view of illustrative pit-shaped structure 122 of FIG. 9. Some or all of structures 122 on edge surface 76 may be protrusions such as bumps or other localized protruding structures (see, e.g., illustrative bump 122 in the cross-sectional view of FIG. 10).

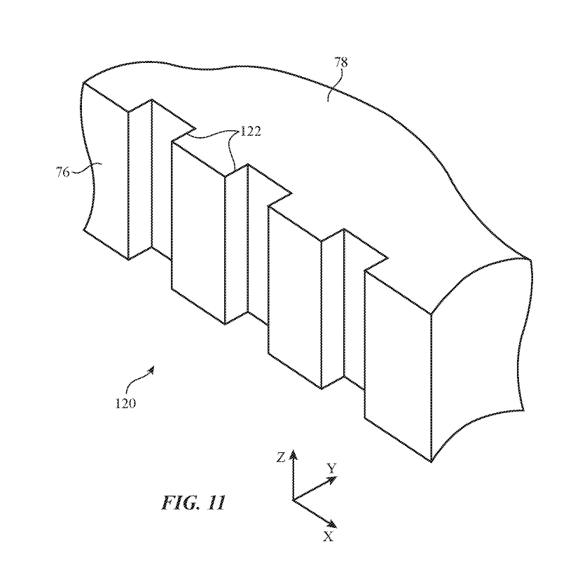

As shown in the example of FIG. 11, surface 76 may be provided with light-scattering structures 120 based on vertically extending structures 122. In the illustrative configuration of FIG. 11, structures 122 have the shape of grooves with rectangular cross-sections that run vertically across the thickness of layer 78 parallel to vertical dimension Z. If desired, vertically extending ribs may protrude from layer 76. The grooves of FIG. 11 have rectangular cross-sectional shapes, but grooves and ribs (e.g., vertically extending grooves and/or ribs) for forming structures 120 may, in general, have any suitable profiles (e.g., semicircular, triangular, etc.). The pitch of structures 122 of FIGS. 8, 9, 10, and 11 and other light-scattering structures 120 on surface 76 may be 30-11 microns, more than 10 microns, more than 20 microns, more than 50 microns, less than 75 microns, less than 80 microns, less than 120 microns, or other suitable pitch.

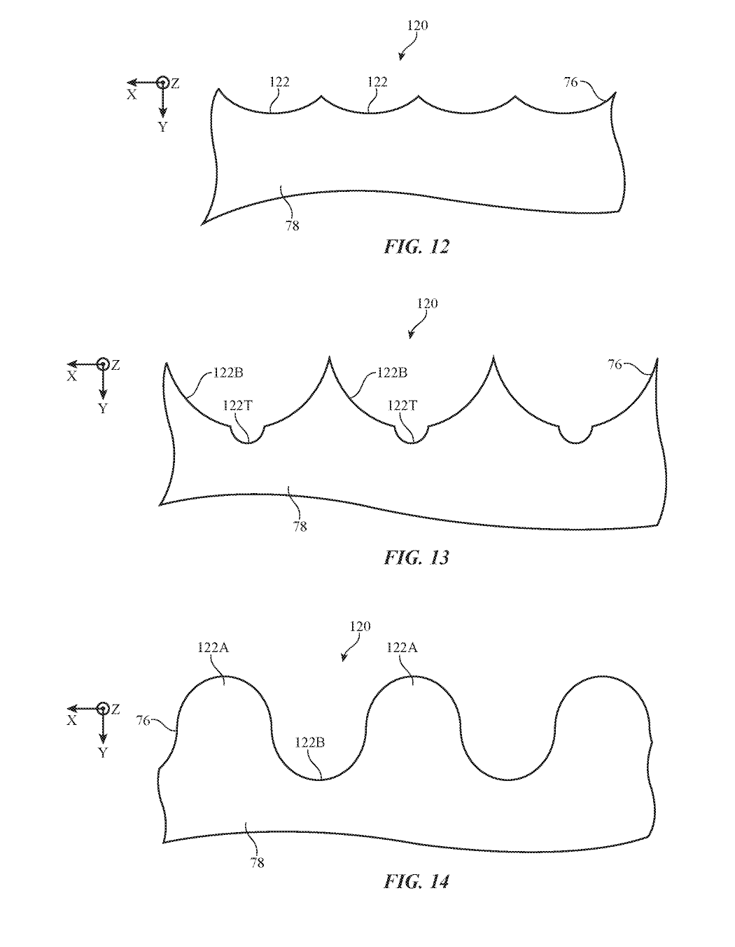

FIGS. 12, 13, and 14 are top views of illustrative edge regions of light guide layer 78 showing how light-scattering structures 120 may be formed from vertically extending scalloped grooves 112. Illustrative grooves 112 of FIG. 12 overlap with each other along their edges to form a serrated edge surface for surface 76 of layer 78. In the example of FIG. 13, edge surface 76 has a double serrated profile created by nesting narrow scalloped recesses 122T within wide scalloped recesses 122B. In the example of FIG. 14, edge surface 76 has an undulating shape created by a series of vertically extending protrusions such as ribs 122A that alternate with adjacent vertically extending recesses such as grooves 122B. The profiles of ribs 122A and 122B of FIG. 14 are semicircular, but other rib and/or groove shapes may be used, if desired (e.g., triangular shapes, rectangular shapes, shapes with combinations of curved and straight edges, etc.).

The foregoing is merely illustrative and various modifications can be made by those skilled in the art without departing from the scope and spirit of the described embodiments. The foregoing embodiments may be implemented individually or in any combination.

What is claimed is:

1. A display having an active area that displays images, comprising:
an array of pixels in the active area; and
a backlight that illuminates the array of pixels in the active area, wherein the backlight includes a light guide layer, wherein the light guide layer is free of holes in the active area and has a border mixing region outside of the active area that has light-scattering holes that pass through the light guide layer.

2. The display defined in claim 1 wherein the light guide layer has an edge surface and wherein the backlight includes an array of light-emitting diodes along the edge surface that emit light into the light guide layer through the edge surface.

3. The display defined in claim 2 wherein the light-scattering holes include at least one row of light-scattering holes in the border mixing region that extend parallel to the edge surface.

4. The display defined in claim 3 wherein the array of pixels comprises an array of liquid crystal display pixels.

5. The display defined in claim 2 wherein the light-scattering holes include at least three rows of light-scattering holes that extend parallel to the edge surface in the border mixing region.

6. The display defined in claim 2 wherein the light-scattering holes are cylindrical holes and have diameters of 10-80 microns.

7. The display defined in claim 2 wherein the light-scattering holes comprise at least two rows of light-scattering holes in the border mixing region.

8. The display defined in claim 7 wherein the light-scattering holes in the border mixing region comprise laser-drilled holes.

9. The display defined in claim 8 further comprising light-scattering structures on the edge surface.

10. The display defined in claim 9 wherein the light-scattering structures comprise laser-processed light-scattering structures.

11. The display defined in claim 9 wherein the light-scattering structures on the edge surface comprise bumps.

12. The display defined in claim 9 wherein the light-scattering structures on the edge surface comprise pits.

13. The display defined in claim 9 wherein the light guide layer has opposing upper and lower surfaces and wherein the light-scattering structures on the edge surface extend across the edge surface between the upper and lower surfaces.

14. The display defined in claim 13 wherein the light-scattering structures comprise grooves in the edge surface.

15. A display that displays images in an active area, comprising:
an array of pixels in the active area;
a backlight that provides backlight illumination for the array of pixels in the active area, wherein the backlight includes:
a light guide layer having an edge surface and having light-scattering holes that pass through the light guide layer, wherein the light guide layer is free of holes in the active area and has a border light mixing region in which the light-scattering holes are formed; and
a light source that emits light into the edge surface, wherein the light is homogenized by the light-scattering holes as the light traverses a mixing distance into the light guide layer from the edge surface through the border light mixing region.

16. The display defined in claim 15 wherein the light source comprises a plurality of light-emitting diodes that extend along the edge surface.

17. The display defined in claim 16 further comprising light-scattering structures on the edge surface.

18. The display defined in claim 17 wherein light-scattering holes include at least two rows of cylindrical laser-drilled holes in the border light mixing region.

19. A display having an active area in which images are displayed, comprising:
an array of pixels that displays the images in the active area; and
a backlight that produces illumination for the array of pixels, wherein the backlight includes an array of light-emitting diodes and includes a light guide layer, wherein the light guide layer has light-scattering through holes in a border mixing region that is not overlapped by the active area, wherein the light-scattering through holes in the border mixing region homogenize light emitted into an edge surface of the light guide layer from the array of light-emitting diodes, and wherein the light guide layer is free of light-scattering through holes in the active area.

20. The display defined in claim 19 wherein the light-scattering through holes include at least three rows cylindrical laser-drilled holes formed in a strip of the light guide layer that extends parallel to the edge surface and that forms the border mixing region.
